(19) United States
(12) Patent Application Publication
(10) Pub. No.: US 2025/0124461 A1
(43) Pub. Date: Apr. 17, 2025

(54) DETERMINING CONFIGURABLE COMPONENT PARAMETERS USING MACHINE LEARNING TECHNIQUES

(71) Applicant: Dell Products L.P., Round Rock, TX (US)

(72) Inventors: Siamak Saliminejad, Austin, TX (US); Angel Hernandez, Kansas City, MO (US); Prateek Srivastava, Cedar Park, TX (US); S Jagannath, Bangalore (IN); Azeem Ahmad, Round Rock, TX (US); Olena Teytelman, Moseley, VA (US); Juraj Mecír, Velke Kostolany (SK); David Masaryk, Jacovce (SK)

(21) Appl. No.: 18/379,765

(22) Filed: Oct. 13, 2023

(51) Int. Cl. G06Q 30/0202

(52) U.S. Cl. CPC G06Q 30/0202

(57) ABSTRACT

Methods, apparatus, and processor-readable storage media for determining configurable component parameters using machine learning techniques are provided herein. An example computer-implemented method includes forecasting demand data for at least one component in connection with one or more temporal periods by processing component-related data using one or more machine learning techniques; determining information pertaining to one or more modifications associated with the at least one component; determining, by processing at least a portion of the demand data and at least a portion of the information pertaining to the one or more modifications using at least one designated algorithm, one or more configurable component parameter values attributed to the at least one component and at least a portion of the one or more modifications; and performing one or more automated actions based at least in part on at least one of the one or more configurable component parameter values.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Components such as, for example, various devices, systems and/or other products, commonly include and/or are associated with a number of different parameters related to operations, transactions, etc. For example, component-related decisions enable enterprises to set and/or modify objective-driven component parameters while considering internal and/or external market changes. Such decisions can also involve attempts to forecast component demand and component value, which is made increasingly challenging when dealing with highly configurable components (e.g., laptops, cars, mobile devices, etc.). However, conventional component management techniques often include resource-intensive and error-prone processes related to determining component parameters.

### SUMMARY

Illustrative embodiments of the disclosure provide techniques for determining configurable component parameters using machine learning techniques.

An exemplary computer-implemented method includes forecasting demand data for at least one component in connection with one or more temporal periods by processing component-related data using one or more machine learning techniques. The method also includes determining information pertaining to one or more modifications associated with the at least one component. Additionally, the method includes determining, by processing at least a portion of the demand data and at least a portion of the information pertaining to the one or more modifications using at least one designated algorithm, one or more configurable component parameter values attributed to the at least one component and at least a portion of the one or more modifications. Also, the method further includes performing one or more automated actions based at least in part on at least one of the one or more configurable component parameter values.

Illustrative embodiments can provide significant advantages relative to conventional component management techniques. For example, problems associated with resource-intensive and error-prone processes are overcome in one or more embodiments through automatically determining configurable component parameter values attributed to at least one component and one or more modifications thereof using one or more machine learning techniques and at least one designated algorithm.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for determining configurable component parameters using machine learning techniques in an illustrative embodiment.

FIG. 2 shows an example workflow within system architecture for determining configurable component parameters using machine learning techniques in an illustrative embodiment.

FIG. 3 shows example pseudocode for demand curve creation and evaluation using a meta model in an illustrative embodiment.

FIG. 4 shows example pseudocode for carrying out upgrade and price optimizations using an example genetic algorithm (GA) in an illustrative embodiment.

FIG. 5 is a flow diagram of a process for determining configurable component parameters using machine learning techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

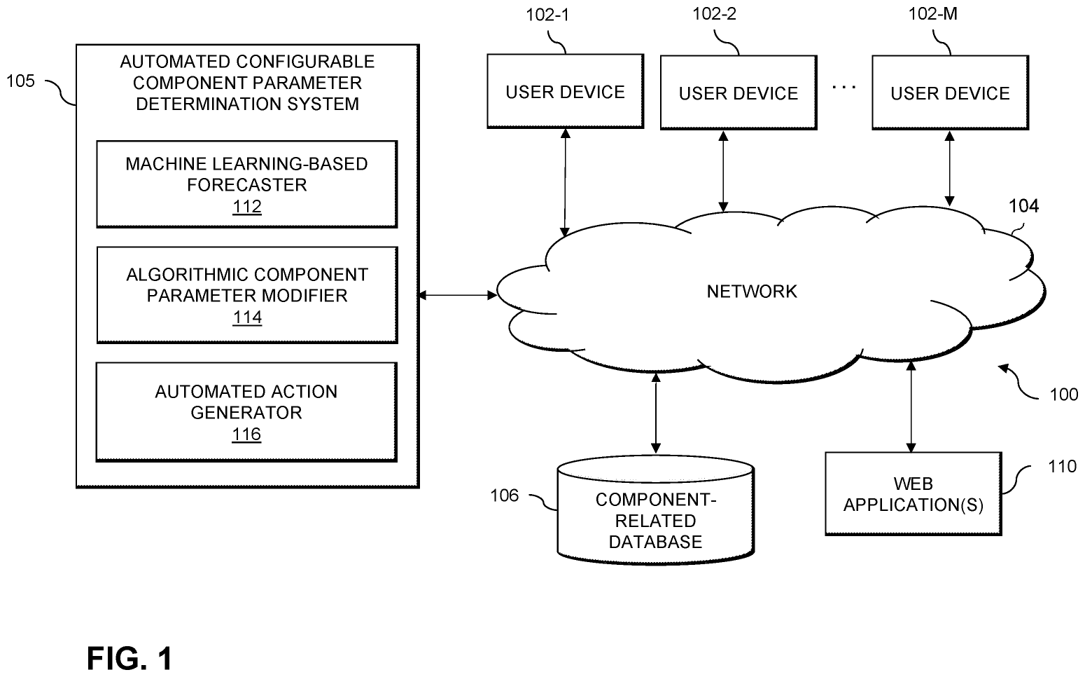

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated configurable component parameter determination system 105 and web application(s) 110.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated configurable component parameter determination system 105 can have an associated component-related database 106 configured to store data pertaining to component demand information, component modification information, historical component pricing information, component-related temporal information, etc.

The component-related database 106 in the present embodiment is implemented using one or more storage systems associated with automated configurable component parameter determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated configurable component parameter determination system 105 are one or more input-output devices, which illustratively comprise keyboards, displays or other types of input-output devices in any combination. Such input-output devices can be used, for example, to support one or more user interfaces to automated configurable component parameter determination system 105, as well as to support communication between automated configurable component parameter determination system 105 and other related systems and devices not explicitly shown.

Additionally, automated configurable component parameter determination system 105 in the FIG. 1 embodiment is assumed to be implemented using at least one processing device. Each such processing device generally comprises at least one processor and an associated memory, and implements one or more functional modules for controlling certain features of automated configurable component parameter determination system 105.

More particularly, automated configurable component parameter determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated configurable component parameter determination system 105 to communicate over the network 104 with the user devices 102, and illustratively comprises one or more conventional transceivers.

The automated configurable component parameter determination system 105 further comprises machine learning-based forecaster 112, algorithmic component parameter modifier 114, and automated action generator 116.

It is to be appreciated that this particular arrangement of elements 112, 114 and 116 illustrated in the automated configurable component parameter determination system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for determining configurable component parameters using machine learning techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated configurable component parameter determination system 105, component-related database 106, and web application(s) 110 (e.g., one or more electronic commerce (e-commerce) web applications, one or more component support web applications, one or more enterprise-related web applications, etc.) can be on and/or part of the same processing platform.

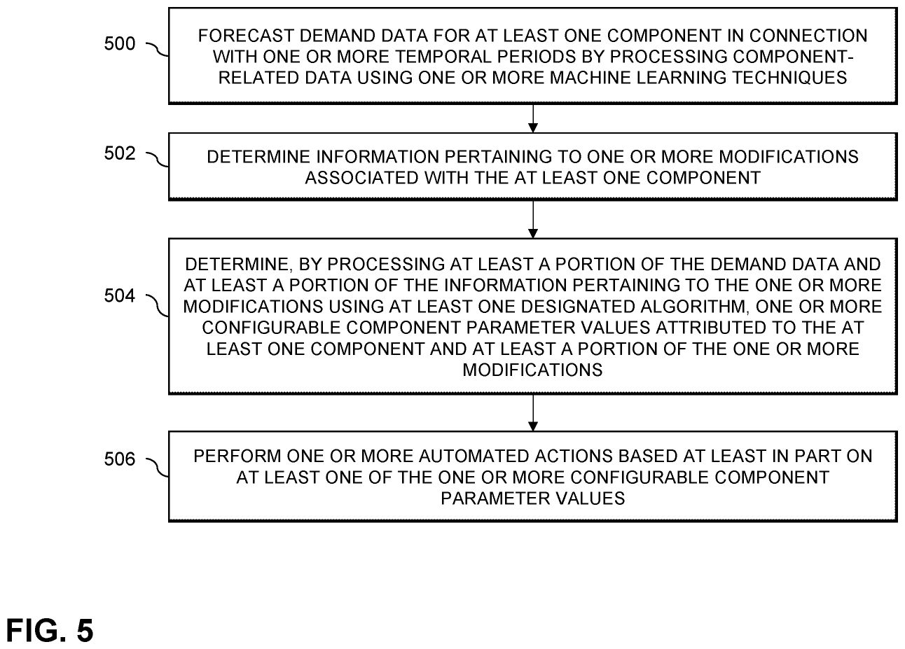

An exemplary process utilizing elements 112, 114 and 116 of an example automated configurable component parameter determination system 105 in computer network 100 will be described in more detail with reference to the flow diagram of FIG. 5.

Accordingly, at least one embodiment includes determining configurable component parameters using machine learning techniques. By way of example, an example embodiment includes determining optimal pricing of configurable products using machine learning techniques. As further detailed herein, such an embodiment can include modeling configuration upgrades as a means to determine interpretable component prices. For instance, the price of a given component, p_{B}, can include the price of some base configuration component, p_{A}, plus one or more configuration upgrade prices that a user incurs when upgrading from component version A to component version B.

At least one embodiment includes using a combination of machine learning models to forecast component demand, along with an optimization framework to determine at least one parameter such as, e.g., price(s) and/or upgrades that achieve one or more objectives (e.g., one or more enterprise goals). Such an embodiment can include implementing a component upgrade optimizer to derive at least one upgrade policy for the given component that is used to calculate prices over multiple versions of the given component. Additionally, such an embodiment can further include implementing a component price optimizer to derive component prices that are a function of the at least one upgrade policy and achieve one or more predefined objectives. In one or more embodiments, both optimizers can utilize machine learning-generated demand curves to accurately estimate user demand over multiple component prices.

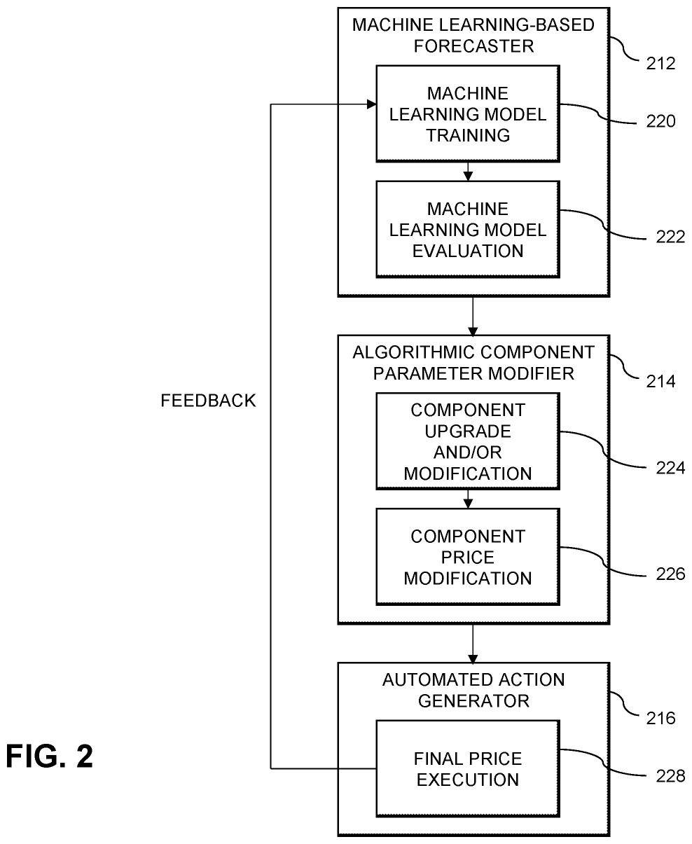

FIG. 2 shows an example workflow within system architecture for determining configurable component parameters using machine learning techniques in an illustrative embodiment. By way of illustration, FIG. 2 depicts an example workflow of processes that are executed in sequential order to arrive at a final selling price of a given component (e.g., a product). Accordingly, in connection with machine learning-based forecaster 212, such an example embodiment includes determining one or more configurable component parameters by training, in step 220, at least one machine learning model to forecast one or more variables related to the component, and evaluating, in step 222, the at least one trained machine learning model with respect to multiple outputs. Such an example embodiment can also include, in connection with algorithmic component parameter modifier 214, using at least one algorithm (e.g., at least one GA) to determine, in step 224, one or more component upgrades and/or modifications, and using the at least one algorithm to determine, in step 226, one or more component price modifications associated with at least a portion of the one or more component upgrades and/or modifications. Further, as depicted in FIG. 2, in connection with automated action generator 216, step 228 includes executing one or more final selling prices based at least in part on the one or more determined upgrades and/or modifications as well as the one or more determined price modifications related thereto. In such an example embodiment, feedback related to the price(s) executed in step 228 can be provided and/or fed back to the machine learning and used in training and/or fine-tuning in further instances of step 220.

Accordingly, at least one embodiment includes determining one or more configurable component prices. Such an embodiment can include training at least one machine learning forecasting model to generate one or more component demand curves. By way merely of example, such an embodiment can include using one or more gradient boosting techniques (e.g., LightGBM) and/or one or more regression techniques (e.g., multiple linear regression (MLR)) to perform component demand forecasting. At least one example embodiment includes using one or more gradient boosting techniques (e.g., LightGBM) and one or more regression techniques (e.g., MLR) in combination to forecast a given component's demand. Model evaluation can then be used as a meta model to select the best demand curve for the given component. By way of example, for a given component, there may be multiple demand curves from multiple different models, and in one or more embodiments, a meta model is implemented to select the demand curve which is best for the component according to an evaluation score calculated on holdout data, if the product has history already; otherwise the meta model uses the best model's demand curve generally.

Accordingly, using a combination stacked with a meta model enables at least one embodiment to accurately forecast components with different market behaviors. The best demand curve for a given component can then be used in one or more optimizers to infer, e.g., the forecasted units expected to be sold at any given price point.

Such an example embodiment can include utilizing at least one algorithm such as, for instance, at least one GA, to determine one or more upgrade and/or component modification prices (e.g., optimal upgrade and/or component modification prices) a user will pay when upgrading and/or modifying between two given component configuration attributes. As used herein, an example GA comprises a heuristic that searches for the best solution that minimizes or maximizes a defined objective function. At each learning step, an example GA generates a new solution based at least in part on results from one or more previous evaluated solutions. Also, an example GA is known to converge to an optimal solution when the learning steps tend towards infinity, and an example GA can be used to solve non-linear optimization problems.

An alternative solution to at least one GA can include reinforcement learning, which can include, for example, using a neural network and back propagation to traverse many different solutions in order to arrive at some best solution. A difference between at least one GA and reinforcement learning is how these two systems traverse different solutions, as the at least one GA uses results from previous solutions to evolve the next set of solutions to be traversed, and reinforcement learning uses back propagation to arrive at the next solution that should be traversed.

Accordingly, in at least one embodiment, at least one algorithm (e.g., at least one GA) can also be used to recommend component prices that will meet one or more predetermined objectives (e.g., enterprise objectives such as units, revenue, etc.), wherein such component prices are a function of at least one upgrade and/or component modification policy learned and/or determined as noted above.

Further, such an example embodiment can additionally include reviewing forecasting accuracy of the demand forecasting combination, comparing one or more upgrade and/or component modification prices to prices derived from one or more benchmarks and/or data sources (e.g., one or more component-related experts), comparing recommended component prices to existing component prices, and analyzing performance of the attainment of the one or more predetermined objectives with respect to such prices.

With respect to determining and/or forecasting component demand curves, one or more embodiments include training a combination of multiple machine learning models (e.g., regression models) and at least one meta model that decides which of the machine learning models should be applied to what component(s). A demand curve, in an example embodiment, can describe the relationship between component parameters such as price and expected units sold in the next stability period, wherein a stability period is defined as the amount of time (e.g., the number of days) during which price is not expected to change. For each component and each machine learning model in the combination, such an embodiment includes estimating how many units are expected to be sold at each of multiple possible prices. To reduce computation time, infeasible and/or unlikely prices can be removed from the solution space (e.g., prices outside of a range encompassing 20% below a current and/or established price to 20% above a current and/or established price).

Accordingly, given a component, a range of price points, and a machine learning model from the combination, such an embodiment can include running inference over all such price points and determining the total expected demand for the defined stability period. This can result, for example, in price-unit pairs that constitute the demand curve for the given component and the given machine learning model. Also, the meta model can be used to select the best demand curve for a given component based at least in part on a model evaluation process further detailed herein.

With respect to component price optimization, in such a problem setting, a user can select a given component family, j, wherein j∈(1, . . . , M) and M is the total number of component families. Each component family has Nⱼ total components associated therewith, and p_{(i,j)} represents the price of the i^{th} component within the j^{th} family. In one or more embodiments, the price of the component is governed by S, the set of attributes a user can customize. A given attribute can be denoted with s and a given attribute value can be denoted as s^{(k)}, wherein s=(s⁽¹⁾, . . . , s^{(ls)}), s∈S, and lₛ is the number of attributes values associated with a given attribute. For example, a “memory” attribute (e.g., for a component such as a laptop or a mobile device) could have the following values: (4 gigabytes (GB), 8 GB, 16 GB, 32 GB), and l_{Memory}=4.

Additionally, in at least one embodiment, a constraint (e.g., an enterprise constraint) of the pricing algorithm detailed herein can indicate, for example, that the price must be a function of attribute upgrades and upgrade prices must be consistent across all component families. For instance, assume that component A is configured with base attribute values and is selling at price p_{A}, but a given user wants to upgrade the memory attribute on component A from 4 GB to 8 GB. This upgrade results in a new component, B, and the price of component B, p_{B}, must be expressed as seen in Formula-1 below:

$${p}_{B} = {p}_{A} + {δ}_{Memory} ( 4 GB , 8 GB )$$

wherein δₛ(s^{(k)}, s^{(k+τ)})→R, i.e., the amount the user will always pay when upgrading between two attributes, creating an intuitive pricing experience for the user.

With respect to defining and/or determining component prices, one or more embodiments can include defining how the pricing algorithm detailed herein will calculate the price of any given component across multiple upgrades and/or modifications. At least one embodiment can include using and/or establishing a base component price before determining pricing associated with attribute upgrades and/or modifications across versions of the component. For example, assume that p_{A} is the base price in Formula-1 noted above. Such an embodiment can include assigning the base price to be the price of the first component in each family, i.e., p_{(1,j)}. Also, it is noted that components within a given family can sorted in ascending order based on their cost, c(i, j), such that c(1,j)<c(2,j)< . . . <c(Nⱼ,j)∀j∈(1, . . . , M).

Additionally, in at least one embodiment, gₛ(i, j) represents a lookup a function for a given attribute that maps a provided component to its attribute value, i.e., gₛ(i, j)→s^{(k)}, wherein s^{(k)}∈s. Referring again, for example, to Formula-1, in such an embodiment, δ_{Memory}(A)=4 GB.

Also, knowing that, in one or more embodiments, p_{(1,j)} will be the base price and gₛ(i, j) maps components to their attribute value, Formula-2 can formally define the price of a given component as follows:

$${p}_{( i , j )} = {p}_{( 1 , j )} + {\sum }_{s ∈ S} {δ}_{s} ( {g}_{s} ( 1 , j ) , {g}_{s} ( i , j ) ) ∀ i > 1$$

Accordingly, a derived price includes the base component's price plus the total upgrade and/or modification amount that occurred between these two components. Also, similar to component prices, attribute values can be sorted in ascending order based on their cost.

With respect to pricing objectives, a pricing methodology associated with one or more embodiments operates in accordance with one or more guidelines. For example, such guidelines might include that an upgrade and/or component modification policy must be persistent over time and should not be adjusted too frequently (which can ensure consistent upgrade prices are presented to users), and that component prices should achieve one or more enterprise-defined objectives (e.g., revenue, margin, units, etc.) wherein such objectives and prices are subject to change over time (e.g., to reflect the current market).

Due to the persistent nature of a given upgrade and/or component modification policy, one or more embodiments include using multiple optimizers in deriving final component prices. In at least one example embodiment, such optimizers include an upgrade and/or component modification optimizer and price optimizer, as further detailed below and herein.

With respect to an example upgrade and/or component modification optimizer, let P₁ represent the set of base prices over all component families, i.e., P₁=(p_{(1,1)}, p_{(1,2)}, . . . , p_{(1,M)}). Because the price of base components are the only prices that are not a function of upgrades, their price can be explicitly learned during optimization.

The next set of decision variables is the upgrade and/or component modification price between two attribute values with a given attribute, δₛ(s^{(k)}, s^{(k+τ)}). In at least one embodiment, let δₛ represent the set of upgrade and/or component modification prices that are modeled for a given attribute. Within a given attribute, such an embodiment can include modeling every possible permutation between the selection of two attribute values, i.e.,

$$\vert {δ}_{( s )} \vert = \frac{{l}_{s} !}{( {l}_{s} - 2 ) !} .$$

Modeling these decision variables accordingly can lead, for example, to a learned upgrade and/or component modification policy that is counterintuitive to a user (e.g., because the user might expect the upgrade and/or component modification prices to grow monotonically as attributes are upgraded to higher values (e.g., δ_{Memory}(4 GB, 32 GB)>δ_{Memory}(4 GB, 16 GB)>δ_{Memory}(4 GB,8 GB))). As a result, one or more embodiments include modeling single-step upgrade and/or component modification amounts that are additive and persistent.

Knowing that, in an example embodiment, attribute values can be sorted in ascending order based on cost, such an embodiment includes only modeling single-step upgrades within a given attribute, i.e., δₛ=(δₛ(s⁽¹⁾, s⁽²⁾), δₛ(s⁽²⁾, s⁽³⁾), . . . , δₛ(s^{(l}^{ₛ}⁻¹⁾, s^{(l}^{ₛ}⁾)). This can reduce the size of a given attribute's decision variables to |δₛ|=lₛ−1. Further, all attribute decision variable upgrade and/or component modification prices can be denoted as D, i.e., D={δₛ}s∈S.

When an upgrade and/or component modification between two components is encountered that is not single-step, at least one embodiment can include adding-up all single-step upgrade and/or component modification amounts in between the two components. For example, δₛ(s⁽¹⁾, s⁽³⁾)=δₛ(s⁽¹⁾, s⁽²⁾)+δₛ(s⁽²⁾, s⁽³⁾), which can result in an intuitive upgrade and/or component modification policy.

Additionally, it can be the case that some attributes are upgraded and other attributes are downgraded when comparing two different components. In such an instance, at least one embodiment can include ensuring one or more decision variables are persistent by multiplying proposed single-step upgrade and/or component modification prices by −1. For example, δₛ(s⁽³⁾, s⁽²⁾)=−δₛ(s⁽²⁾,s⁽³⁾). Formally, proposed upgrade and/or component modification price decision variables within a given attribute can be defined in Formula-3 (a), Formula-4 (b), and Formula-5 (δₛ(s^{(k)}, s^{(k+r)})) as follows:

$$a = {\sum }_{i = 0}^{τ - 1} {δ}_{s} ( {s}^{( k + i )} , {s}^{( k + i + 1 )} )$$

$$b = {\sum }_{i = 0}^{\vert τ \vert - 1} {δ}_{s} ( {s}^{( k + i )} , {s}^{( k + i + 1 )} )$$

$${δ}_{s} ( {s}^{( k )} , {s}^{( k + τ )} ) = \{ \begin{matrix}a & τ > 0 \\ b & τ < 0 \\ 0 & τ = 0\end{matrix}$$

Also, as detailed herein, at least one embodiment includes determining optimal component base prices, \hat{p}₁, and upgrade and/or component modification prices, \hat{D}, that maximizes one or more predefined objectives (e.g., enterprise revenue). Such an embodiment includes using one or more machine learning-generated demand curves to obtain forecasted component demand at a given component price. In such an embodiment, the demand estimation obtained and/or derived from a demand curve can be denoted as f_{θ}(p_{(i,j)})→R, wherein this function returns the real-valued units for a given component at a given price. By way of example, a projected enterprise objective (e.g., revenue) of a given component and the preliminary objective function of the upgrade and/or component modification optimizer, are defined below in Formula-6 (r_{(i,j)}) and Formula-7 ((\hat{p}₁, \hat{D})), respectively, as follows:

$${r}_{( i , j )} = ( {p}_{( i , j )} - {c}_{( i , j )} ) {f}_{θ} ( {p}_{( i , j )} )$$

$$( {\hat{p}}_{1} , \hat{D} ) = {arg max}_{{p}_{1} , D} {\sum }_{j = 1}^{M} {\sum }_{i = 1}^{{N}_{j}} {r}_{( i , j )}$$

If Formula-7 is expanded using Formula-2, it is clear that upgrade and/or component modification price decision variables, D, are present in the objective function.

In connection with objective function penalties, there are types of soft constraints to be satisfied by applying a penalty to the objective function. Such soft constraints can include, for example, a valid price range (e.g., min p(i, j)<p(i,j)<max p(i,j)), and monotonic prices (e.g., p(i+1,j)>p(i,j)∀i∈(1, . . . , Nⱼ−1)). The first soft constraint will ensure the price of a given component does not deviate outside a predefined range (e.g., must be greater than cost and less than the maximum historical selling price), and the second soft constraint will ensure prices increase as the cost of the component increases.

Referring again to Formula-6, assume that r_{(i,j)} is the enterprise objective that considers these soft constraints. Below, Formula-8 formally defines when the objective function is penalized:

$${\tilde{r}}_{( i , j )} = \{ \begin{matrix}{r}_{( i , j )} & {p}_{( i , j )} < {max}_{p ( i , j )} and \\ & {p}_{( i , j )} > {min}_{p ( i , j )} and \\ & {p}_{( i , j )} > {p}_{( i , j )} \\ - λ {r}_{( i , j )} & otherwise\end{matrix}$$

The penalty factor is denoted as > and setting this penalty to some large value can ensure that at least one GA converges to satisfy these soft constraints.

One or more embodiments can also include enforcing one or more hard constraints on proposed decision variables to ensure that at least one GA converges to a given pricing policy. In such an embodiment, a given component family's base price, p(1, j), can be limited to a range of valid prices. Because base product prices are decision variables, the price range of these products can be controlled explicitly. Additionally, in such an embodiment, base component prices are modeled as integers.

Similarly, for upgrade and/or component modification prices, one or more embodiments can also include defining a range of values such decision variables can take on. Because a proposed upgrade and/or component modification policy can be both additive and persistent, such an embodiment includes only needing to constrain each single-step upgrade, δₛ(s^{(k)}, s^{(k+1)}), across all attributes. Also, min_{δ}_{ₛ}(s^{(k)}, s^{(k+1)}) and max_{δ}_{ₛ}(s^{(k)}, s^{(k+1)}) represents the lower value and higher value a given upgrade and/or component modification price can take on, respectively. These decision variables can also be modeled as integers, and historical configuration cost data can be used to derive enterprise-related intuitive ranges.

With respect to a price optimizer, and by way merely of example, assume that the enterprise objectives are defined quarterly and at the brand level, b. Objective variables used in the proposed objective function, wherein each variable is a real number, are defined below as follows:
q∈(1, . . . , 4):=A given quarter
U_{b}^{q}:=The total unit objective for a given brand within a given quarter
R_{b}^{q}:=The total revenue objective for a given brand within a given quarter
Ū_{b}^{q}:=The actual quarter-to-date units for a given brand
R̅_{b}^{q}:=The actual quarter-to-date revenue for a given brand

In an example embodiment, the price optimizer can be run for a given brand and will only contain component families associated with the given brand wherein each brand contains Mb number of component families. In such an embodiment, let P₁^{b} represent the set of base component prices associated with a given brand, i.e., P₁^{b}=(p_{(1,1)}, p_{(1,2)}, . . . , p_{(1,M}_{_{b}}₎). The optimal upgrade and/or component modification policy learned via the upgrade and/or component modification optimizer, \hat{D}, and Formula-2 can be used to calculate the price of all other non-base components. As a result, changing a given base component price will change all other prices within a given family, which will allow at least one GA to learn a new set of optimal base component prices, \hat{p}₁^{b}, that maximize one or more enterprise objectives over the entire brand. Below the objective function for a given brand is formally defined and further detailed.

As additionally described below, consider Formula-9 (r_{b}), Formula-10 (u_{b}), Formula-11 (û_{b}), Formula-12 (r̅_{b}), and Formula-13 (\hat{P}₁^{b}), defined, respectively, as follows:

$${r}_{b} = {\sum }_{j = 1}^{{M}_{b}} {\sum }_{i = 1}^{{N}_{j}} {r}_{( i , j )}$$

$${u}_{b} = {\sum }_{j = 1}^{{M}_{b}} {\sum }_{i = 1}^{{N}_{j}} {f}_{θ} ( {p}_{( i , j )} )$$

$${\overline{u}}_{b} = \frac{{u}_{b} + {\overline{U}}_{b}^{q}}{{U}_{b}^{q}}$$

$${\overline{r}}_{b} = \frac{r + {\overline{R}}_{b}^{q}}{{R}_{b}^{q}}$$

$${\hat{P}}_{1}^{b} = {arg max}_{{P}_{1}^{b}} \{ \begin{matrix}{\overline{r}}_{b} + {\overline{u}}_{b} - & {\overline{r}}_{b} < 1 or {\overline{u}}_{b} < 1 \\ ( \vert {\overline{r}}_{b} - {\overline{u}}_{b} \vert ) {w}_{1} & \\ {\overline{r}}_{b} + {\overline{u}}_{b} & otherwise\end{matrix}$$

In Formula-9 and Formula-10, at least one embodiment can include using component demand curves and an optimal upgrade and/or component modification policy, \hat{D}, to calculate the forecasted objective(s). In Formula-11 and Formula-12, such an embodiment can include taking the proposed projected metric, adding-in the corresponding quarter-to-date value, and dividing added total by the quarterly objective. Also, u_{b} and r_{b} effectively represent the projected objective(s) attainment. Formula-13 defines a proposed multi-objective function. When there is more than one objective, attainment can be calculated considering all individual objectives and their relative importance, wherein w₁ is a value between [0,1) and controls the importance of proportional attainments.

By way merely of illustration, consider an example embodiment involving a use case pertaining to laptops sold in a given geography during a given year. The dataset used in such a use case includes a combination of two years of sales and component (i.e., laptop) data. Sales data includes information on the cost, baseline price(s), promotional price(s), and number of units sold. Component data includes time-invariant information about the component itself, such as component category, brand, and configurations.

The granularity of such data can be transformed, in this example use case, to a stability period of 28 days, wherein the target is the number of units sold in the following stability period with the average price during that time period. Daily granularity data can be aggregated using a sliding window, and additional features can be added to the dataset such as one or more autoregressive features (e.g., units sold, average price occurring in the previous 28 days, etc.), holidays, and time-related information (e.g., day in the year, days from the first day of data, days from the latest sales of the given component, etc.). The data can then be cleaned, and outliers and/or duplicates can be removed. Missing features in the data can then be imputed using model-specific and/or column-specific methods.

Such an example embodiment includes training a stacking combination of two types of models, MLR and LightGBM. The MLR model can be trained with L2 regularization to prevent overfitting the model on a small subset of features. Many of the features can show a non-linear relationship with the target, and as such, the example embodiment can include applying logarithmic transformation and multiplying the features with the price. The target can also be transformed with a logarithmic function.

LightGBM can be trained on all features globally, which can render the model more effective for components, for example, with limited or no sales history. Additionally, the LightGBM model can produce non-monotonic demand curves, which can more accurately reflect real-world demand. The post-processing of such optimal pricing of configurable components using machine learning curves can involve the use of at least one sliding linear regression window. Specifically, linear regression can be applied to segments of a curve (with the objective, e.g., of predicting units based on price) and constrained to fit non-positive coefficients, resulting in a non-decreasing curve.

Additionally, in at least one embodiment, one or more tree-based models, which are sensitive to hyper-parameter settings, can be implemented. Accordingly, such an embodiment can include using Bayesian optimization to increase and/or maximize performance. One or more such models can be fitted on geography (e.g., country) and segment combination level data (e.g., U.S., online customer model). After such models are fitted, at least one embodiment includes selecting the best model for every component using a similar evaluation method.

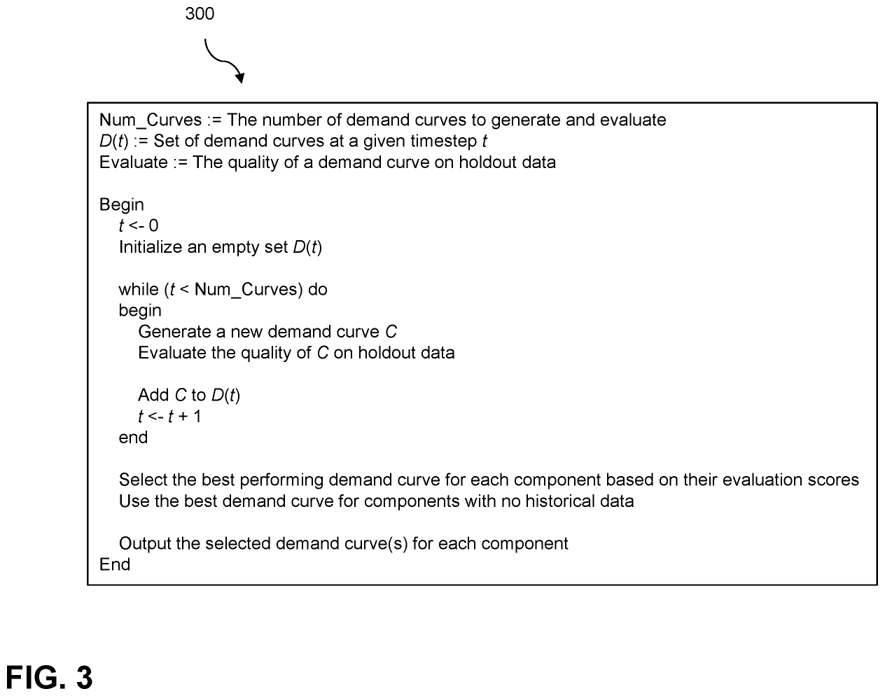

FIG. 3 shows example pseudocode for demand curve creation and evaluation using a meta model in an illustrative embodiment. In this embodiment, example pseudocode 300 is executed by or under the control of at least one processing system and/or device. For example, the example pseudocode 300 may be viewed as comprising a portion of a software implementation of at least part of automated configurable component parameter determination system 105 of the FIG. 1 embodiment.

The example pseudocode 300 illustrates, using a meta model and based at least in part on the number of demand curves to generate and evaluate, and the set of demand curves at a given timestep 1, evaluating the quality of a demand curve on holdout data. Additionally, example pseudocode 300 illustrates selecting the best performing demand curve for each component based on their evaluation scores, using the best demand curve for components with no historical data, and outputting the selected demand curve(s) for each component.

It is to be appreciated that this particular example pseudocode shows just one example implementation of demand curve creation and evaluation using a meta model, and alternative implementations can be used in other embodiments.

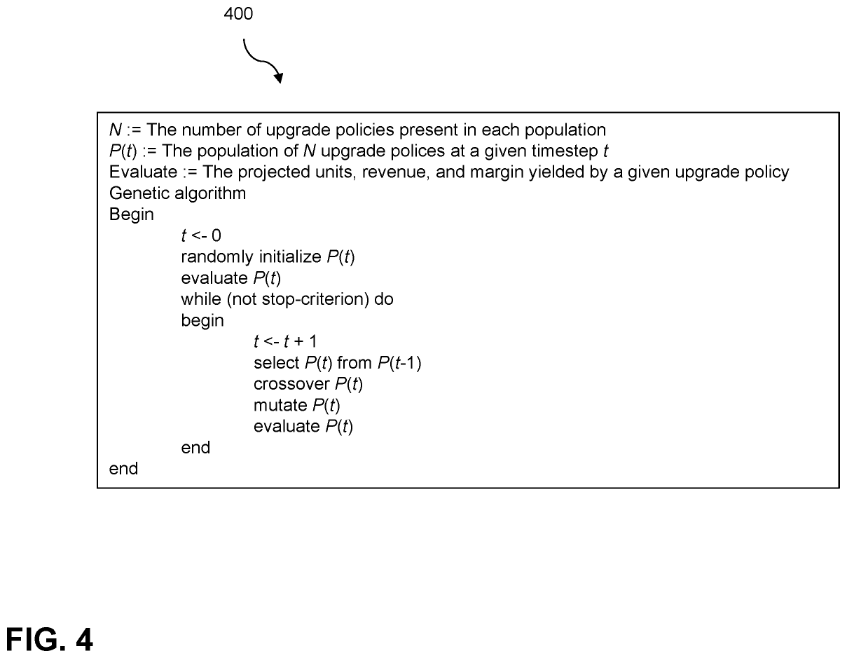

FIG. 4 shows example pseudocode for carrying out upgrade and price optimizations using an example GA in an illustrative embodiment. In this embodiment, example pseudocode 400 is executed by or under the control of at least one processing system and/or device. For example, the example pseudocode 400 may be viewed as comprising a portion of a software implementation of at least part of automated configurable component parameter determination system 105 of the FIG. 1 embodiment.

The example pseudocode 400 illustrates, using the example GA and based at least in part on the number of upgrade policies present in each population and the population of N upgrade polices at a given timestep t, evaluating the projected units, revenue, and margin yielded by a given upgrade policy.

It is to be appreciated that this particular example pseudocode shows just one example implementation of carrying out upgrade and price optimizations using an example GA, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations and/or predictions. For example, one or more of the models described herein may be trained to generate recommendations and/or predictions based at least in part on component demand data and component modification information, and such recommendations and/or predictions can be used to initiate one or more automated actions (e.g., executing component prices, automatically training machine learning techniques based at least in part on the recommendations and/or predictions, etc.).

FIG. 5 is a flow diagram of a process for determining configurable component parameters using machine learning techniques in an illustrative embodiment. It is to be understood that this particular process is only an example, and additional or alternative processes can be carried out in other embodiments.

In this embodiment, the process includes steps 500 through 506. These steps are assumed to be performed by automated configurable component parameter determination system 105 utilizing elements 112, 114 and 116.

Step 500 includes forecasting demand data for at least one component in connection with one or more temporal periods by processing component-related data using one or more machine learning techniques. In at least one embodiment, forecasting demand data for the at least one component includes processing component-related data using one or more gradient boosting techniques. Also, in at least one embodiment, forecasting demand data for the at least one component includes processing component-related data using one or more regression techniques. Additionally or alternatively, forecasting demand data for the at least one component can include processing component-related data using a combination of one or more gradient boosting techniques and one or more regression techniques. Further, forecasting demand data for the at least one component can include processing component-related data using one or more tree-based models in conjunction with one or more Bayesian optimization techniques to increase model performance.

Step 502 includes determining information pertaining to one or more modifications associated with the at least one component. In one or more embodiments, determining information pertaining to one or more modifications associated with the at least one component includes identifying at least one of one or more hardware upgrades for the at least one component and one or more software upgrades for the at least one component.

Step 504 includes determining, by processing at least a portion of the demand data and at least a portion of the information pertaining to the one or more modifications using at least one designated algorithm, one or more configurable component parameter values attributed to the at least one component and at least a portion of the one or more modifications. In at least one embodiment, determining one or more configurable component parameter values includes processing the at least a portion of the demand data and the at least a portion of the information pertaining to the one or more modifications using at least one genetic algorithm. Additionally or alternatively, determining one or more configurable component parameter values can include processing the at least a portion of the demand data and the at least a portion of the information pertaining to the one or more modifications using the at least one designated algorithm in conjunction with one or more predetermined constraints.

Step 506 includes performing one or more automated actions based at least in part on at least one of the one or more configurable component parameter values. In one or more embodiments, performing one or more automated actions includes automatically training at least a portion of the one or more machine learning techniques using feedback related to the at least one of the one or more configurable component parameter values. Also, in at least one embodiment, the one or more configurable component parameter values can include one or more prices attributed to the at least one component and at least a portion of the one or more modifications, and in such an embodiment, performing one or more automated actions includes executing at least one of the one or more prices in connection with at least one component-related offering to one or more users.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically determine configurable component parameter values attributed to at least one component and one or more modifications thereof using one or more machine learning techniques and at least one designated algorithm. These and other embodiments can effectively overcome problems associated with resource-intensive and error-prone processes.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

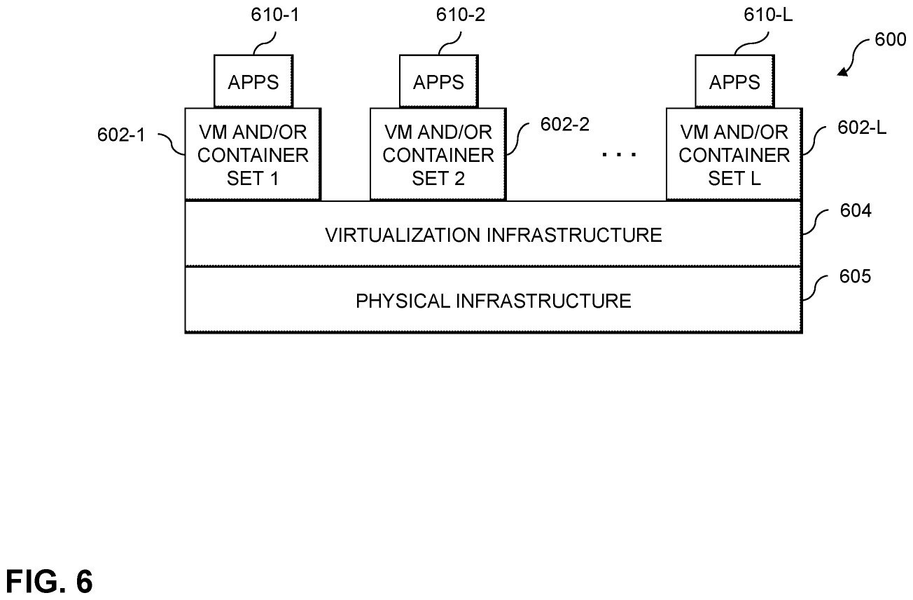

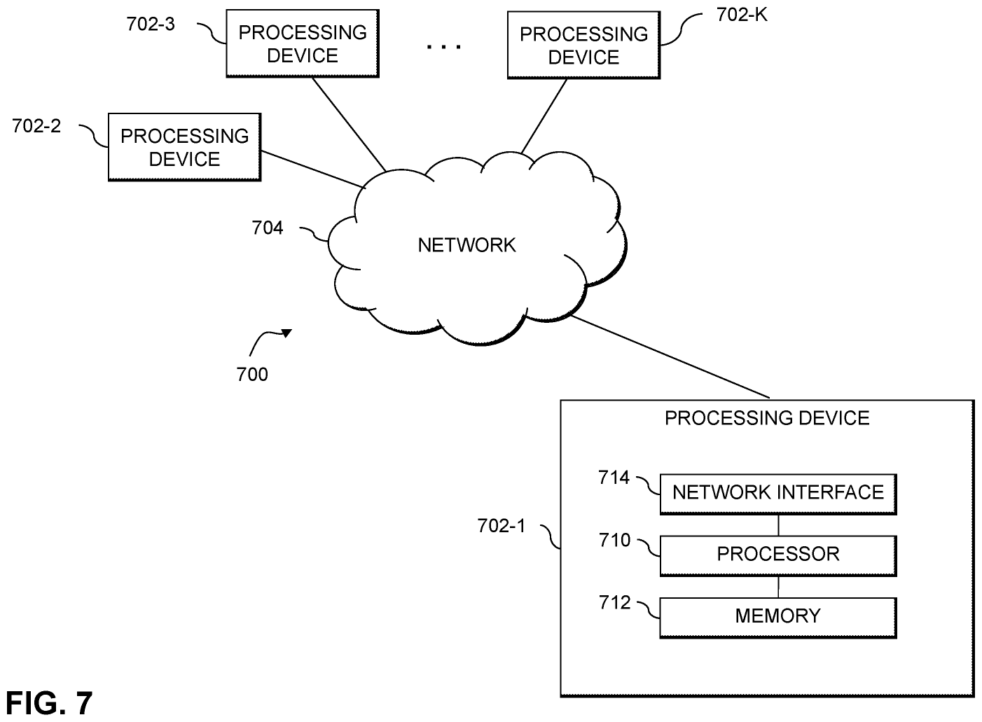

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
forecasting demand data for at least one component in connection with one or more temporal periods by processing component-related data using one or more machine learning techniques;
determining information pertaining to one or more modifications associated with the at least one component;
determining, by processing at least a portion of the demand data and at least a portion of the information pertaining to the one or more modifications using at least one designated algorithm, one or more configurable component parameter values attributed to the at least one component and at least a portion of the one or more modifications; and
performing one or more automated actions based at least in part on at least one of the one or more configurable component parameter values;
wherein the method is performed by at least one processing device comprising a processor coupled to a memory.

2. The computer-implemented method of claim 1, wherein forecasting demand data for the at least one component comprises processing component-related data using one or more gradient boosting techniques.

3. The computer-implemented method of claim 1, wherein forecasting demand data for the at least one component comprises processing component-related data using one or more regression techniques.

4. The computer-implemented method of claim 1, wherein forecasting demand data for the at least one component comprises processing component-related data using a combination of one or more gradient boosting techniques and one or more regression techniques.

5. The computer-implemented method of claim 1, wherein determining one or more configurable component parameter values comprises processing the at least a portion of the demand data and the at least a portion of the information pertaining to the one or more modifications using at least one genetic algorithm.

6. The computer-implemented method of claim 1, wherein determining one or more configurable component parameter values comprises processing the at least a portion of the demand data and the at least a portion of the information pertaining to the one or more modifications using the at least one designated algorithm in conjunction with one or more predetermined constraints.

7. The computer-implemented method of claim 1, wherein performing one or more automated actions comprises automatically training at least a portion of the one or more machine learning techniques using feedback related to the at least one of the one or more configurable component parameter values.

8. The computer-implemented method of claim 1, wherein the one or more configurable component parameter values comprises one or more prices attributed to the at least one component and at least a portion of the one or more modifications, and wherein performing one or more automated actions comprises executing at least one of the one or more prices in connection with at least one component-related offering to one or more users.

9. The computer-implemented method of claim 1, wherein forecasting demand data for the at least one component comprises processing component-related data using one or more tree-based models in conjunction with one or more Bayesian optimization techniques to increase model performance.

10. The computer-implemented method of claim 1, wherein determining information pertaining to one or more modifications associated with the at least one component comprises identifying at least one of one or more hardware upgrades for the at least one component and one or more software upgrades for the at least one component.

11. A non-transitory processor-readable storage medium having stored therein program code of one or more software programs, wherein the program code when executed by at least one processing device causes the at least one processing device:
to forecast demand data for at least one component in connection with one or more temporal periods by processing component-related data using one or more machine learning techniques;
to determine information pertaining to one or more modifications associated with the at least one component;
to determine, by processing at least a portion of the demand data and at least a portion of the information pertaining to the one or more modifications using at least one designated algorithm, one or more configurable component parameter values attributed to the at least one component and at least a portion of the one or more modifications; and
to perform one or more automated actions based at least in part on at least one of the one or more configurable component parameter values.

12. The non-transitory processor-readable storage medium of claim 11, wherein forecasting demand data for the at least one component comprises processing component-related data using a combination of one or more gradient boosting techniques and one or more regression techniques.

13. The non-transitory processor-readable storage medium of claim 11, wherein determining one or more configurable component parameter values comprises processing the at least a portion of the demand data and the at least a portion of the information pertaining to the one or more modifications using at least one genetic algorithm.

14. The non-transitory processor-readable storage medium of claim 11, wherein performing one or more automated actions comprises automatically training at least a portion of the one or more machine learning techniques using feedback related to the at least one of the one or more configurable component parameter values.

15. The non-transitory processor-readable storage medium of claim 11, wherein the one or more configurable component parameter values comprises one or more prices attributed to the at least one component and at least a portion of the one or more modifications, and wherein performing one or more automated actions comprises executing at least one of the one or more prices in connection with at least one component-related offering to one or more users.

16. An apparatus comprising:
at least one processing device comprising a processor coupled to a memory;
the at least one processing device being configured:
to forecast demand data for at least one component in connection with one or more temporal periods by processing component-related data using one or more machine learning techniques;
to determine information pertaining to one or more modifications associated with the at least one component;
to determine, by processing at least a portion of the demand data and at least a portion of the information pertaining to the one or more modifications using at least one designated algorithm, one or more configurable component parameter values attributed to the at least one component and at least a portion of the one or more modifications; and
to perform one or more automated actions based at least in part on at least one of the one or more configurable component parameter values.

17. The apparatus of claim 16, wherein forecasting demand data for the at least one component comprises processing component-related data using a combination of one or more gradient boosting techniques and one or more regression techniques.

18. The apparatus of claim 16, wherein determining one or more configurable component parameter values comprises processing the at least a portion of the demand data and the at least a portion of the information pertaining to the one or more modifications using at least one genetic algorithm.

19. The apparatus of claim 16, wherein performing one or more automated actions comprises automatically training at least a portion of the one or more machine learning techniques using feedback related to the at least one of the one or more configurable component parameter values.

20. The apparatus of claim 16, wherein the one or more configurable component parameter values comprises one or more prices attributed to the at least one component and at least a portion of the one or more modifications, and wherein performing one or more automated actions comprises executing at least one of the one or more prices in connection with at least one component-related offering to one or more users.
